(19) United States
(12) Patent Application Publication
(10) Pub. No.: US 2015/0269397 A1
(43) Pub. Date: Sep. 24, 2015

(54) CARD CONTACT-MAKING APPARATUS

(71) Applicant: AMPHENOL-TUCHEL ELECTRONICS GMBH, Heilbronn (DE)

(72) Inventor: Eckhard Schewe, Heilbronn (DE)

(21) Appl. No.: 14/437,367

(22) PCT Filed: Sep. 14, 2013
(86) PCT No.: PCT/EP2013/002775

§ 371 Date: Apr. 21, 2015

(30) Foreign Application Priority Data
Nov. 7, 2012 (DE) 10 2012 021 673.4

(51) Int. Cl. G06K 7/00; H01R 13/62; H01R 12/70; H01R 13/635

(52) U.S. Cl. CPC G06K 7/003; H01R 13/635; H01R 13/62; H01R 12/707; H01R 12/7064

(57) ABSTRACT

The invention relates to a card contact-making apparatus for a card for installation in an installation assembly, wherein the card contact-making apparatus has an upper and a lower contact carrier receptacle and a flexible contact carrier, which is arranged between the upper and lower contact carrier receptacle, wherein the lower contact carrier receptacle forms a plurality of fastening means which are adapted for Listening on an installation assembly.

The present invention relates to a card contact-making apparatus as claimed in claim 1.

In the prior art, card-reading apparatuses which comprise a card contact-making apparatus for making contact with the corresponding card are used to make contact with cards such as SIM cards, memory cards, micro SD cards and other cards.

There is an increasing requirement to reduce the physical size, in particular the thickness, of the card contact-making apparatus.

Therefore, the prior art contains different measures for reducing the card thickness. By way of example, in the case of SIM card contact-making apparatuses which have a moving cover, the bearing points of the contact-making apparatus have, for example, been fitted to the side of the contact carrier such that a the inserted card is moved from a pre-installation position to a final-installation position by means of a control mechanism on the top face of the contact carrier. It was possible to reduce the thickness of a corresponding contact carrier in this way.

Further measures which are known in the prior art are, for example, the reduction of the material thicknesses used as such. Therefore, it is possible, for example, for the contact carrier, which has the reading contacts, to be reduced to a minimum height. One problem with this is that as the material thickness falls, the stability of the contact carriers is no longer adequate for use in the majority of applications. A further problem arises with the coplanarity of the reading contacts. The connection ends of the reading contacts in a contact carrier ideally have to lie in one plane, so that the process of soldering onto a printed circuit board can be implemented in a reliable manner.

This necessarily leads to problems in the case of unstable contact carriers.

In addition to the problem with the contact carrier thickness, there is also a requirement to be able to use the contact carrier in different applications without, however, having to rely on providing the contacts for making contact with a corresponding card on the in the superordinate component or in a superordinate installation assembly as early as during the manufacturing process.

In this respect, it is necessary, when designing the printed circuit board of a mobile radio terminal device or another electrical application in which smartcards are used, to already define at a very early stage the point at which the conductor tracks for the contacts for making contact with a card are to be provided.

This makes product design difficult and restricts development in respect of flexible and small designs being possible.

The object of the present invention is therefore to provide a thin card contact-making apparatus which can be positioned freely on an installation assembly.

A further object of the present invention is therefore to provide a card contact-making apparatus which can be placed directly in substantially any desired position on an installation assembly and of which the reading contacts for making contact with the card can be connected to a printed circuit board which may be positioned at a distance, by means of a preferably flexible connection.

The present object is achieved by a card contact-making apparatus as claimed in claim 1.

Further particular embodiments of the contact-making apparatus according to the invention can be found in the dependent claims and also in the following drawings and the description of the exemplary embodiments.

A further object of the present invention is to provide a card contact-making apparatus with a push-push mechanism, so that a card can be inserted into the card contact-making apparatus by means of a first push and from the card contact-making apparatus by means of a second push (pressure on the card) via a contact carrier support, preferably via a lower contact carrier support has or forms a plurality of fastening means which are adapted such that the card contact-making apparatus can be installed directly into an installation assembly, that is to say into a superordinate assembly. The fastening means can be designed in such a way that the card contact-making apparatus can be either pressed into, clipped into or latched by means of snap-action connections into an installation assembly. Fastening means which permit connection to an installation assembly in an interlocking, force-fitting or cohesive manner can also be provided as an alternative.

In this way, it is possible to also arrange the card contact-making apparatus in a mobile terminal device at a distance from the printed circuit board since the card contact-making apparatus according to the invention already has a flexible contact carrier with contacts, and these contacts (reading contacts) can be connected to the printed circuit board in order to make contact with the card by means of a likewise flexible connection.

The assembly step known in the prior art that the reading contacts which are provided by the card contact-making apparatus are connected to the printed circuit board by the card contact-making apparatus being positioned on the printed circuit board with a corresponding solder pattern and being soldered to said printed circuit board at the solder points can therefore be dispensed with.

Therefore, a card contact-making apparatus for a card which is to be installed in or on an installation assembly is proposed, wherein the card contact-making apparatus has an upper and a lower contact carrier support and also a flexible contact carrier which is arranged between the upper and the lower contact carrier support, wherein the lower contact carrier support forms a plurality of fastening means which are adapted in order to be fastened in or on an installation assembly.

In a preferred embodiment, the card contact-making apparatus is further designed such that the upper contact carrier support is in the form of a mating bearing for the top face of a card. In this way, the card which is inserted into the contact support space of the card contact-making apparatus can be pressed by the mating bearing, which forms the upper contact carrier support, against the contact-making face of the flexible contact carrier, so that a reliable connection is ensured between the reading contacts of the flexible contact carrier and the contacts of the card.

The card contact-making apparatus further preferably has fastening means on the lower contact carrier support, said fastening means preferably being in the form of a plurality of holes, in order to be pressed together around or on corresponding, preferably cylindrical, projections on the installation assembly as intended.

Therefore, if the fastening means are in the form of recesses, the card contact-making apparatus can be pushed onto projections and pressed together with them, this allowing particularly simple and cost-effective assembly.

Fastening means are further preferably provided on the lower contact carrier support, said fastening means being in the form of solder points for soldering on or soldering or to the installation assembly as intended.

As an alternative or in addition, these fastening means can be fitted so that it is ensured that the card contact-making apparatus which is pressed together with or fastened to the installation assembly is connected to said installation assembly in a releasable manner and as a result it is also ensured that mechanical impacts can be uncoupled from the installation assembly in the event of shock effects.

According to a preferred application of the solution according to the invention, the installation assembly constitutes an assembly in a mobile radio terminal device, and the flexible contact carrier has a flexible connection for connection to a printed circuit board in the mobile radio terminal device.

Further preferably, the flexible contact carrier has a contact-making section with a plurality of contact points for making contact with a card. A particularly thin card contact-making apparatus can be provided as a result. Furthermore, the number of installation elements is reduced as a result since the flexible contact carrier already comprises the reading contacts.

In a particularly preferred embodiment, the card contact-making apparatus is designed such that the contact-making section (the section in the flexible contact carrier which has the reading contacts) is arranged between the upper and the lower contact carrier support.

The lower contact carrier support preferably has spring arms for pressing the flexible contact carrier against the card.

It is likewise preferred to design the upper contact carrier support with a plurality of cover springs as contact-pressure elements for the top face of a card. Therefore, the card is held, as it were, in a “sandwich-like” manner between the upper and the lower contact carrier support by the contact-presure elements and spring elements and pressed against the contact points of the flexible contact carrier.

A design of this type is particularly suitable since it has already eliminated all tolerance problems in respect of superordinate components independently of the positioning on the installation assembly.

Expressed in other words, this means that the card contact-making apparatus can be installed without the influence of tolerance problems.

In a particularly advantageous embodiment, the card contact-making apparatus according to the invention can be provided in the form of a push-push card contact-making apparatus. Therefore, a card contact-making apparatus with a push-push mechanism with an operator, which can be moved to and fro, for inserting and ejecting a card is proposed.

Since the present invention also has the objective of providing card contact-making apparatuses which are small and of particularly thin construction and can be used in a flexible manner, the solution according to the invention is particularly well suited to nano SIM cards. The present invention therefore also proposes a card contact-making apparatus which is in the form of a nano SIM card reader for receiving a nano SIM card.

A nano SIM card push-push card contact-making apparatus is proposed in particular.

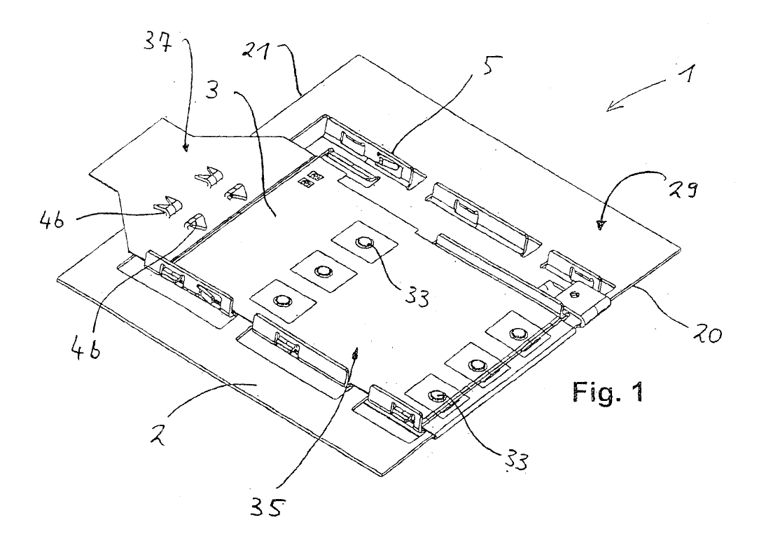

The invention will be explained in greater detail below with reference to FIGS. 1 to 10, in which:

FIG. 1 shows a perspective view of a first exemplary embodiment of a card contact-making apparatus according to the invention;

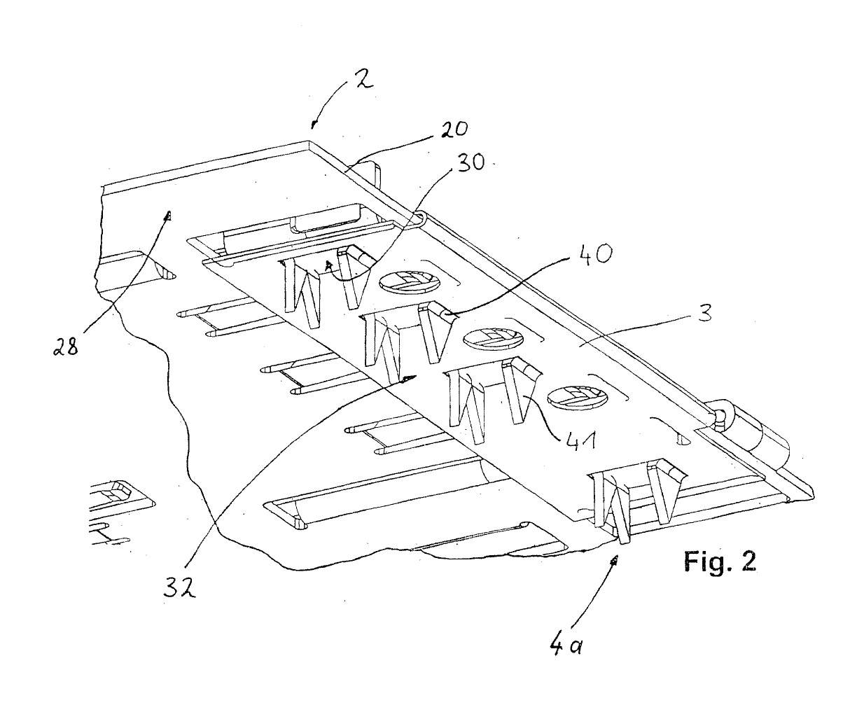

FIG. 2 shows a perspective view of a detail from FIG. 1;

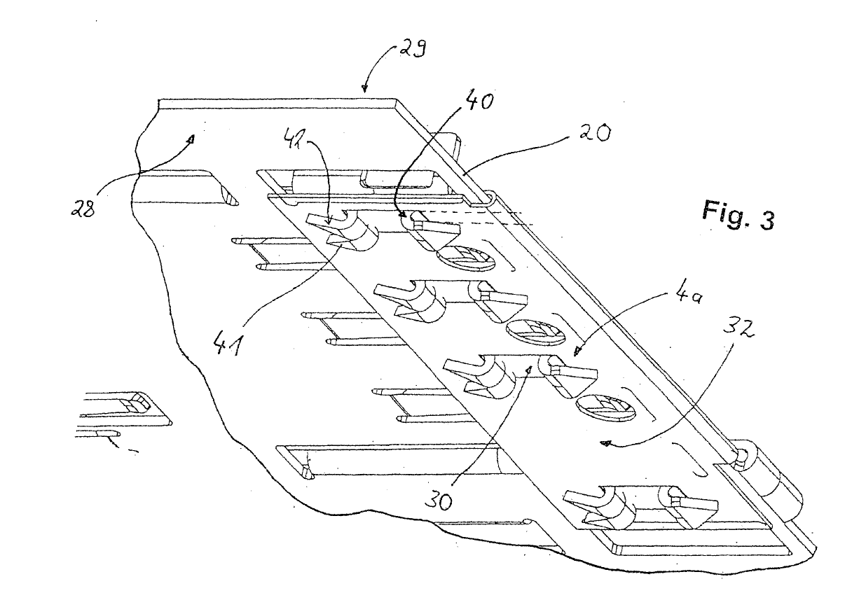

FIG. 3 shows a view of a detail, which is similar to FIG. 2, of a card contact-making apparatus according to the invention in which holding means the flexible contact carrier;

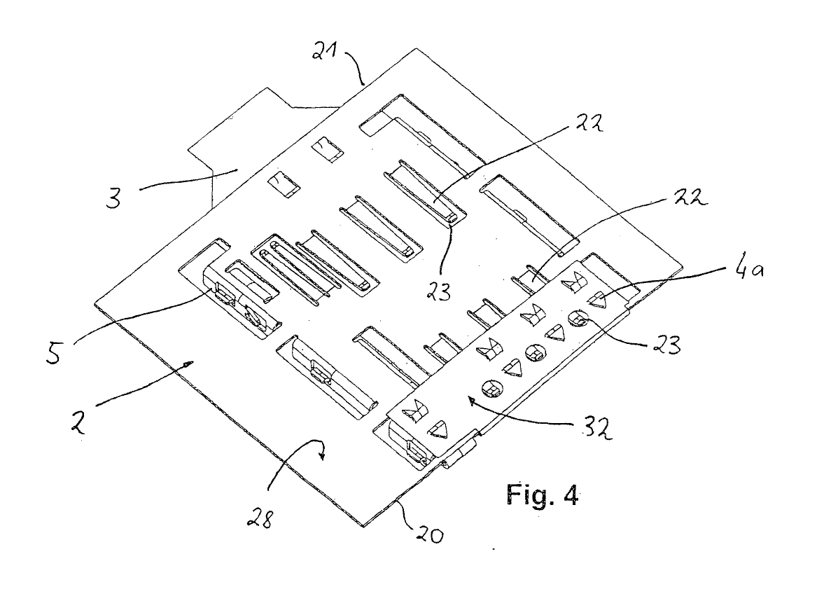

FIG. 4 shows a perspective view of a the card contact-making apparatus according to

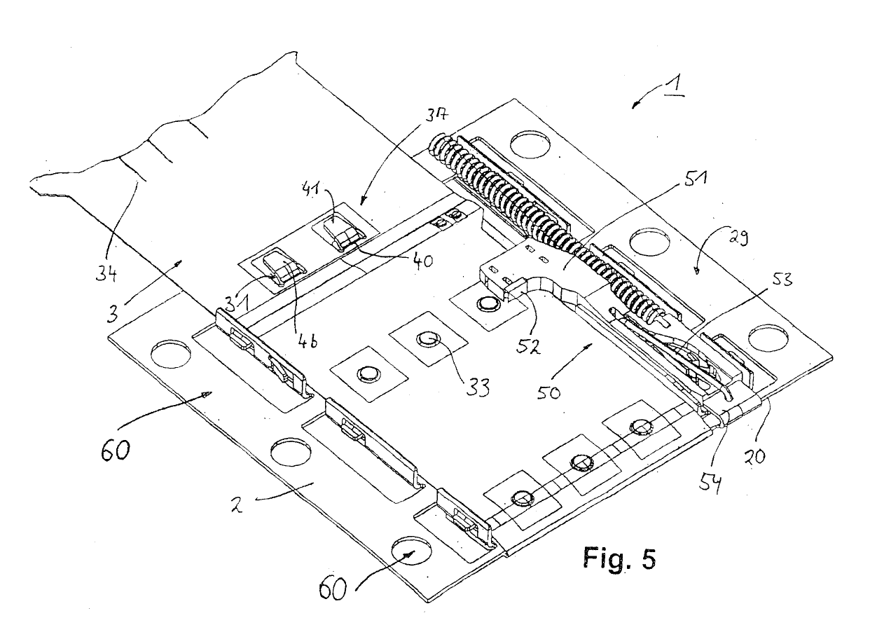

FIG. 5 shows a card contact-making apparatus according to the invention with a push-push mechanism;

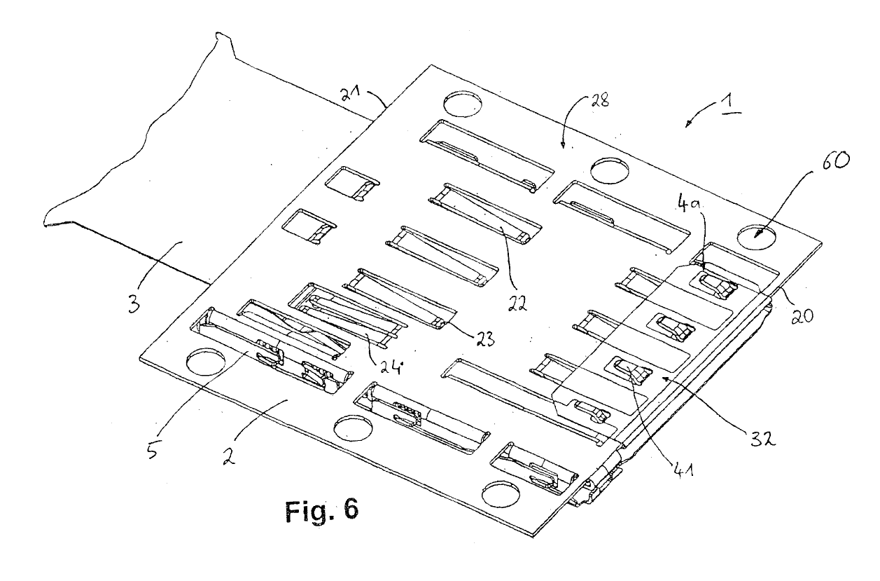

FIG. 6 shows a perspective view of the card contact-making apparatus according to FIG. 5 from below;

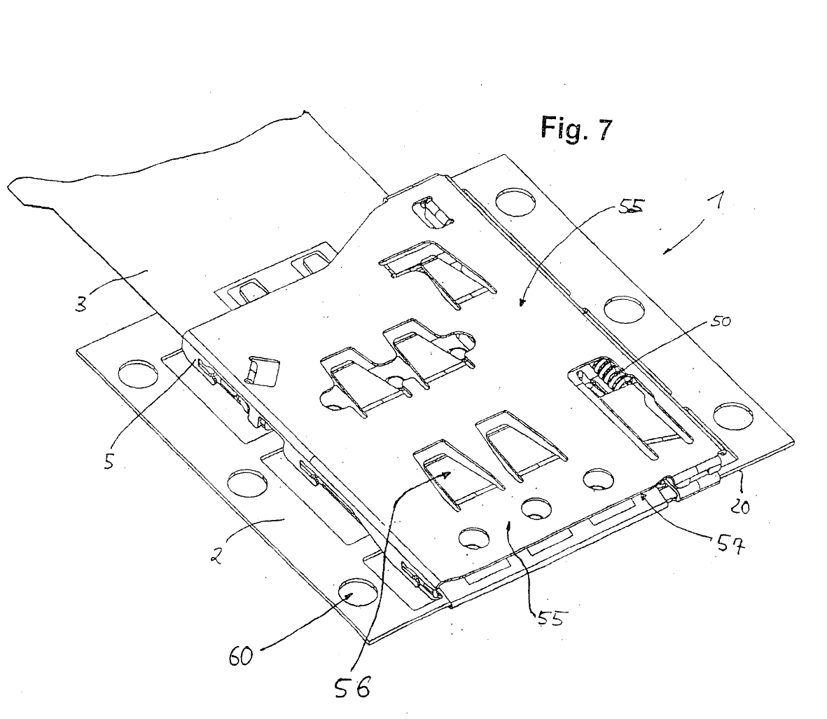

FIG. 7 shows a view, which is similar to FIG. 5, with an upper contact carrier support;

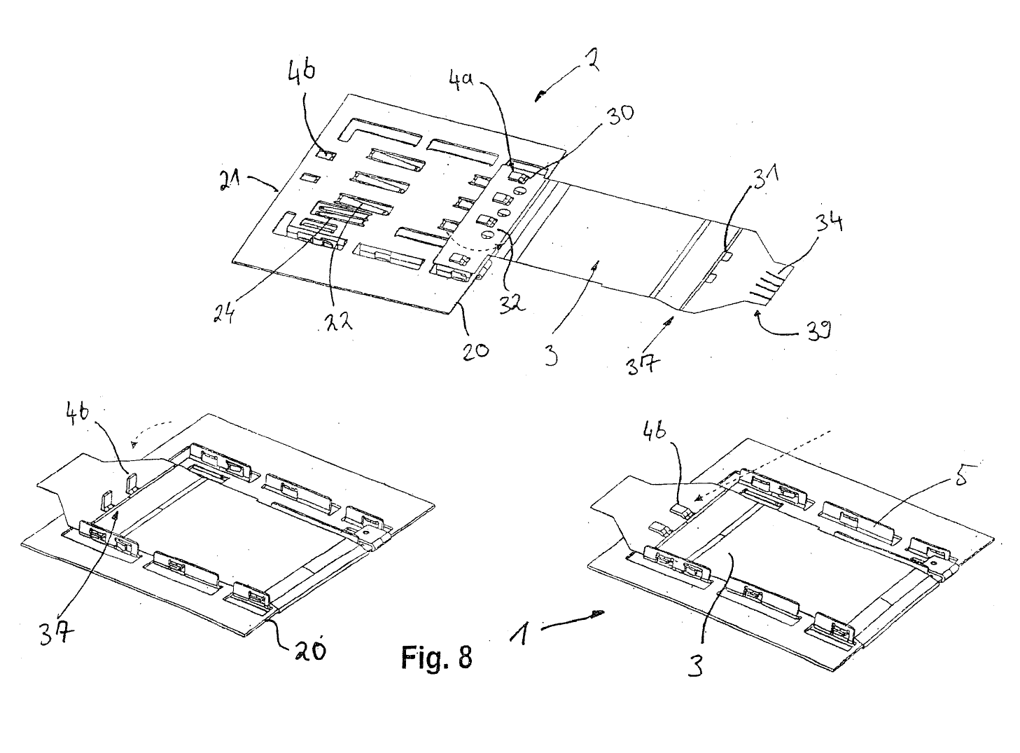

FIG. 8 shows three of the method steps for producing the card contact-making apparatus according to the invention;

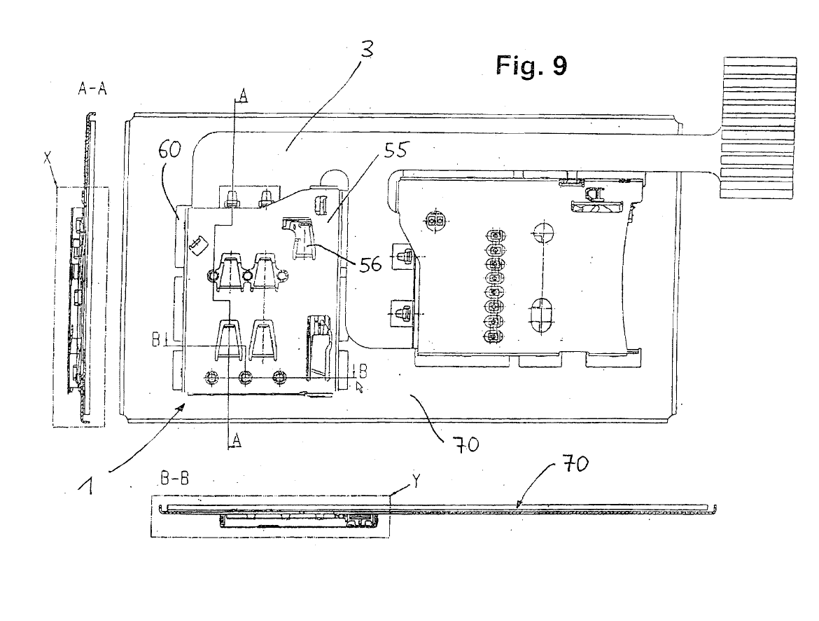

FIG. 9 shows a plan view of a card contact-making apparatus according to the invention which is installed on an installation assembly together with a second card contact-making apparatus; and

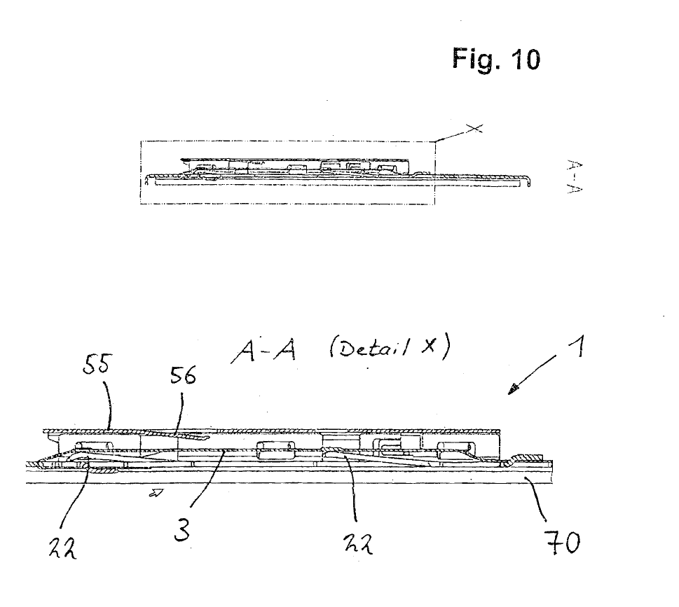

FIG. 10 shows a sectional view along section line A-A with the detail X from FIG. 9.

FIG. 1 shows a perspective view of a first exemplary embodiment of a card contact-making apparatus 1 according to the invention. The card contact-making apparatus 1 comprises a contact carrier 2 which, as depicted here, has been produced as a stamped and bent part from a conventional sheet. According to the invention, a metal sheet is used. The contact carrier support 2 has holding means 4a, 4b. The holding means 4a are clearly shown in FIG. 2 and in FIG. 3.

FIG. 1 further shows that the card contact-making apparatus 1 according to the invention has a flexible contact carrier 3. Within the meaning of the present invention, a flexible contact carrier means a contact carrier 3 which can be bent, reshaped and bent back again. Therefore, it is necessary in any event for the flexible contact carrier 3 to be able to be folded over around a side edge 20 of the card contact-making apparatus 1, as shown in FIG. 1 to FIG. 3. The flexible contact carrier 3 has six contact points 33 on its surface here. The contact points 33 are arranged in accordance with the contact-making grid of the corresponding card 100. The contact carrier support 2 further has card stops 5 on the right-hand side and left-hand side. The contact carrier support 2 further has a side edge 20 and a side edge 21 which is situated opposite the side edge 20 (transversely running side edges 20, 21).

The side face, illustrated in FIG. 1, of the contact carrier support 2 is designated side face 29 and represents the top face of the contact carrier support 2. The bottom face, which is situated opposite the side face 29, constitutes the side face 28, as is shown in FIG. 2 and in FIG. 3. The holding means 4a are located on the side face 28, while holding means 4b are provided on the side face 29.

As shown in FIG. 2, the holding means 4a protrude through recesses 30 in the contact carrier, and are in a pre-installation position here. By bending over the holding sections 41 around the fastening sections 40 with which the holding means 4a are fastened to the contact carrier support 2, the holding means 4a are moved into the position shown in FIG. 3. In this case, the flexible contact carrier 3 is clamped in and held between an inner face of the holding section 41 and the side face 28 of the contact carrier support 2.

As shown in FIG. 3, a right-hand side and a left-hand side holding means 4a are advantageously provided, so that the flexible contact carrier 3, by way of its recess 30, bears against one side edge of the recess 30 and against the opposite side edge of the recess 30, so that displacement in a longitudinal and transverse direction is precluded. Furthermore, side edges 42 of the holding means 4a form a lateral stop for the recesses 30, so that movement in the transverse direction, that is to say parallel to the side edge 20, is prevented. The flexible contact carrier 3 is securely fastened to the contact carrier support 2 in this way.

A plurality of holding means 4a which are spaced apart from one another and are arranged next to one another are advantageously arranged on the contact carrier support 2 at a distance from the side edge 20 in order to fasten the fastening section 32 at an end of the flexible contact carrier 3 to said contact carrier support.

As is further clearly shown in FIG. 3, the ends of the holding sections 41 are designed with points which can advantageously be crimped into the surface of the flexible contact carrier 3.

In other words, bending over the holding sections 41 in a suitable manner may result in a toothing effect with the flexible contact carrier 3 in which the pointed ends of the holding sections 41 at least partially enter the flexible contact carrier 3, provided that said holding sections are in their final-installation position and run substantially parallel to the side face 28 or to the side face 29.

FIG. 4 shows a perspective view of the side face 28 of the card contact-making apparatus 1 from below. The fastening section 32, specifically the fastening section 32 at an end of the flexible contact carrier 3, is folded around the transversely running side edge 20 and fastened to the holding means 4a. Furthermore, spring arms 22 are formed on the contact carrier support 2. The spring arms 22 protrude, by way of their spring domes 23, at least partially from the side face 29. The spring domes 23 are arranged so as to correspond to the position of the contact areas, with which contact is to be made, of a card 100.

Furthermore, spring arms 24 which likewise have spring domes 23 and project slightly from the side face 29, that is to say from the surface of the contact carrier support 2, are provided. Switching contacts of a flexible contact carrier 3 are located here, said switching contacts being acted on by a spring force by the spring arms 24 when a card 100 is inserted into the card contact-making apparatus 1.

FIGS. 5, 6 and 7 show a first exemplary embodiment according to the invention for forming the lower contact carrier support 2. The lower contact carrier support 2 has fastening means 60 which are arranged on the longitudinal sides of both faces of the card contact-making apparatus 1.

As shown, the fastening means 60 are formed with recesses or are in the form of recesses. In the present exemplary embodiment, the recesses are in the form of holes 60. In this respect, these holes 60 can be pressed together with and connected to corresponding projections of an installation assembly 70.

FIG. 5 shows, in particular, an exemplary embodiment of a push-push card contact-making apparatus 1 according to the invention. This card contact-making apparatus 1 has a push-push mechanism 50. The push-push mechanism 50 serves for inserting and ejecting a card 100, the card being inserted into the card contact-making apparatus 1 by means of a first push on a card 100, specifically into its read position, and the card being moved from its read position to its eject position by means of a second push on the card 100.

The push-push mechanism 50 therefore has an operator 51 which can be moved to and fro. The operator 51 further has a control bar 53. Here, the control bar 53 is illustrated as an elongate wire with two bent-over wire ends. Furthermore, a holding lug 54 is provided on the contact carrier support 2, said holding lug having a recess into which one end of the control bar 53 engages. The other end of the control bar 53 serves for control in a so-called cardioid cam which is likewise provided by the push-push mechanism 50.

Furthermore, a card stop 52 is shown on the operator 51, said card stop extending at least partially above the flexible contact carrier 3 and, when the operator 51 is operated, moving to and fro at least partially above the flexible contact carrier 3.

FIG. 6 illustrates the card contact-making apparatus 1 according to the invention in line with FIG. 5 from below.

In this exemplary embodiment too, a flexible contact carrier 3 is folded over around the transversely running side edge by way of its fastening section 32 at an end, and is held by the holding means 4a which, here, are already bent over in their final-installation position, specifically their bent-over position.

The second fastening section 37 has two recesses 31 through which the holding means 4b are routed, as is shown in FIG. 5. Conductor tracks 34 which, however, run within the flexible contact carrier 3 are also indicated in FIG. 5.

As is further clear from FIG. 6, the contact carrier support 2 likewise has spring arms 22 having spring domes 23. Furthermore, spring arms 24 are provided, which spring arms, like the spring arms 22, project from the surface, that is to say the side face 29, of the contact carrier support 2 by way of their spring domes 23.

In the present exemplary embodiment, the contact carrier support 2 is likewise produced as a stamped grid from a metal sheet. A material which provides the required spring properties for forming the spring arms 22, 24 is a suitable metal material.

The contact carrier support 2 further provides a plurality of bent-over card stops 5 which have upper contact carrier support latching means.

FIG. 7 shows a similar view of the card contact-making apparatus 1 to that in FIG. 5, furthermore in which an upper contact carrier support 55 is connected and latched to the cover latching means of the card stops 5. The upper contact carrier support 55 provides a plurality of contact carrier support springs 56 which protrude into the card-receiving space. A card insertion slot 57 for inserting a card 100 into the card contact-making apparatus 1 runs above the side edge 20.

FIG. 8 shows, in the top view, the provision of a flat contact carrier support 2 having side edges 20, 21, specifically transversely running side edges, wherein the contact carrier support 2 has a plurality of holding means 4a, 4b.

The same view further shows how a flexible contact carrier 3 is provided, said flexible contact carrier having above a first fastening section 32, specifically a fastening section 32 at an end, and a second fastening section 37 which is at a distance from said first fastening section, and wherein the the fastening sections 32, 37 are each provided with recesses 30, 31.

In a first assembly step, the flexible contact carrier 3 is suspended, by way of its first recesses 30 or by way of the recesses 30 in its first fastening section 32 at an end, in the holding means 4a; in this case, the holding means 4a can selectively already be bent over or project from the side face 28 of the contact carrier support 2 and be bent over into the bent-over position illustrated by the top view in FIG. 8.

In a further method step, the flexible contact carrier 3 is bent around the side edge 20, as is shown in the left-hand, bottom view from FIG. 8, and is routed through the holding means 4b by way of its recesses 31 into its fastening section 37. In this case, the flexible contact carrier 3 is folded over around the side edge 20 such that the flexible contact carrier 3 is folded over such that it bears by way of its side face against the side face of the contact carrier support 2.

In this position, the second holding means 4b protrude through the recess 31 in the second fastening section 37.

In a further method step, the holding means 4b are bent over into a position as is shown in the bottom, right-hand view from FIG. 8. The card contact-making apparatus 1 produced in this way can further be provided with an upper contact carrier support 55, which is preferably fastened to card stop means 5 of the contact carrier support 2, so as to form a card-receiving space.

Only the contact points 33 are not illustrated in FIG. 8. However, the flexible contact carrier 3 has corresponding contact points 33.

Furthermore, spring arms 22 can be formed in the contact carrier support 2, preferably by stamping and bending, in a further method step.

Furthermore, the spring arms 22 can preferably be designed with spring domes 23 by reshaping the ends of the spring arms 22, 24 with to form spring domes 23.

FIG. 9 and FIG. 10 show the contact-making apparatus 1 according to the invention in conjunction with an installation assembly 70. As shown, the lower contact carrier support 2 has lateral fastening means 60 by way of which the card contact-making apparatus 1 is connected to an installation assembly 70.

The sectional view along section line A-A shown in FIG. 10 shows the basic design of the card contact-making apparatus according to the invention with the upper and the lower contact carrier support 2, 55 and the flexible contact carrier 3 which is situated between said upper and lower contact carrier support in a “sandwich-like” manner.

The springs 22, 56 are also shown. The springs 56 are upper contact carrier support springs, while the springs 22 constitute spring arms which are formed by the lower contact carrier support.

According to the invention, the installation assembly can also provide individual or several elements which have the card contact-making apparatus. For example, the spring arms 22 can also be arranged on the installation assembly 70. Furthermore, the lower contact carrier support 2 can be formed entirely by the installation assembly 70. Furthermore, further or individual fastening means 60 can also be formed on the upper contact carrier support 55 in order to connect the upper contact carrier support to the installation assembly 70.

### LIST OF REFERENCE SYMBOLS

### Card Contact-Making Apparatus

1 Card contact-making apparatus
2 Lower contact carrier support
3 Flexible contact carrier
4a, 4b Holding means
5 Card stop (card stop means)
20, 21 Side edge
22 Spring arms
23 Spring domes
24 Spring arms
28, 29 Side face
30 Recess (first recess)
31 Recess (second recess)
32 Fastening section at an end
33 Contact points
34 Conductor tracks
35 Contact-making section
37 Fastening section (second fastening section)
39 Opening
40 Fastening section
41 Holding section
42 Side edges
50 Push-push mechanism
51 Operator
52 Card stop
53 Control bar
54 Holding lug
55 Upper contact carrier support
56 Upper contact carrier support springs
57 Card insertion slot
60 Fastening means
70 Installation assembly
80 Lower contact carrier support
100 Card

1. A card contact-making apparatus for a card which is to be installed in an installation assembly, wherein the card contact-making apparatus has a lower and an upper contact carrier support and also a flexible contact carrier which is arranged between the lower and the upper contact carrier support, wherein the lower contact carrier support forms a plurality of fastening means which are adapted in order to be fastened on an installation assembly.

2. The card contact-making apparatus as claimed in claim 1, characterized in that the upper contact carrier support is in the form of a mating bearing for the top face of a card.

3. The card contact-making apparatus as claimed in claim 1, characterized in that fastening means of the lower contact carrier support are in the form of recesses, preferably in the form of a plurality of holes, in order to be pressed together around or on corresponding projections of an installation assembly as intended.

4. The card contact-making apparatus as claimed in claim 1, characterized in that fastening means of the lower contact carrier support are in the form of solder points for soldering to or on an installation assembly as intended.

5. The card contact-making apparatus as claimed in claim 1, characterized in that the installation assembly constitutes an assembly in a mobile radio terminal device, and the flexible contact carrier has a flexible connection for connection to a printed circuit board in the mobile radio terminal device.

6. The card contact-making apparatus as claimed in claim 1, characterized in that the flexible contact carrier has a contact-making section with a plurality of contact points for making contact with a card.

7. The card contact-making apparatus as claimed in claim 6, characterized in that the contact-making section is arranged between the upper and a lower contact carrier support.

8. The card contact-making apparatus as claimed in claim 2, characterized in that the upper contact carrier support provides a plurality of springs as a contact-pressure element for the top face of a card.

9. The card contact-making apparatus as claimed in claim 1, characterized in that the card contact-making apparatus has a push-push mechanism with an operator, which can be moved to and fro, for inserting and ejecting a card.

10. The card contact-making apparatus as claimed in claim 1, characterized in that the contact-making apparatus is a nano SIM card reader for a nano SIM card.
